(19) United States
(12) Patent Application Publication
(10) Pub. No.: US 2018/0217958 A1
(43) Pub. Date: Aug. 2, 2018

(54) Intelligent Connector Module and Bus Control System

(71) Applicant: Tyco Electronics (Shanghai) Co. Ltd., Shanghai (CN)

(72) Inventor: Mingjie Fan, Shanghai (CN)

(73) Assignee: Tyco Electronics (Shanghai) Co. Ltd., Shanghai (CN)

(21) Appl. No.: 15/940,204

(22) Filed: Mar. 29, 2018

Related U.S. Application Data
(63) Continuation of application No. PCT/IB2016/055731, filed on Sep. 26, 2016.

(30) Foreign Application Priority Data
Sep. 30, 2015 (CN) 201520770098.9

(51) Int. Cl. G06F 13/40

(52) U.S. Cl. CPC G06F 13/4068; G06F 2213/40

(57) ABSTRACT

An intelligent connector module is coupled to a bus and a load module of electrical equipment. The intelligent connector module comprises a circuit board, a bus interface connector mounted on the circuit board and coupled to the bus, a load interface connector mounted on the circuit board and coupled to the load module, and a control detection circuit mounted on the circuit board and coupled between the bus interface connector and the load interface connector.

### CROSS-REFERENCE TO RELATED APPLICATIONS

This application is a continuation of PCT International Application No. PCT/IB2016/055731, filed on Sep. 26, 2016, which claims priority under 35 U.S.C. § 119 to Chinese Patent Application No. 201520770098.9, filed on Sep. 30, 2015.

### FIELD OF THE INVENTION

The present invention relates to a connector module and, more particularly, to an intelligent connector module coupled to a bus and a load of electrical equipment.

### BACKGROUND

A control system for a household appliance, such as a washing machine or a refrigerator, generally has a centralized control system. The centralized control system has only one controller; all of the external executing components, such as a valve or a motor, and/or sensing components are directly connected to the one controller. Control switches and sensor circuits of the control system are all integrated into a main control board and connected to all loads. Certain components having complicated control and concentrated functions, such as a variable frequency motor and a user display and control interface, are formed as a plurality of modules and communicate by serial ports. The modules themselves are connected to the relevant switches and sensor circuits according to their functions.

A centralized control system is generally particular to an individual household appliance. The control system is not applicable to a range of household appliances and may only control and detect some given loads. Once the loads are changed, a main control board of the household appliance must be designed again. Further, once a certain electronic element is damaged, the whole main control board has to be replaced, leading to high repair costs.

### SUMMARY

An intelligent connector module is coupled to a bus and a load module of electrical equipment. The intelligent connector module comprises a circuit board, a bus interface connector mounted on the circuit board and coupled to the bus, a load interface connector mounted on the circuit board and coupled to the load module, and a control detection circuit mounted on the circuit board and coupled between the bus interface connector and the load interface connector.

### BRIEF DESCRIPTION OF THE DRAWINGS

The invention will now be described by way of example with reference to the accompanying Figures, of which:

FIG. 1 is a block diagram of a bus control system of electrical equipment according to an embodiment;

FIG. 2 is a block diagram of an intelligent connector module of the bus control system of FIG. 1; and

FIG. 3 is a schematic plan view of the intelligent connector module of FIG. 2.

### DETAILED DESCRIPTION OF THE EMBODIMENTS

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

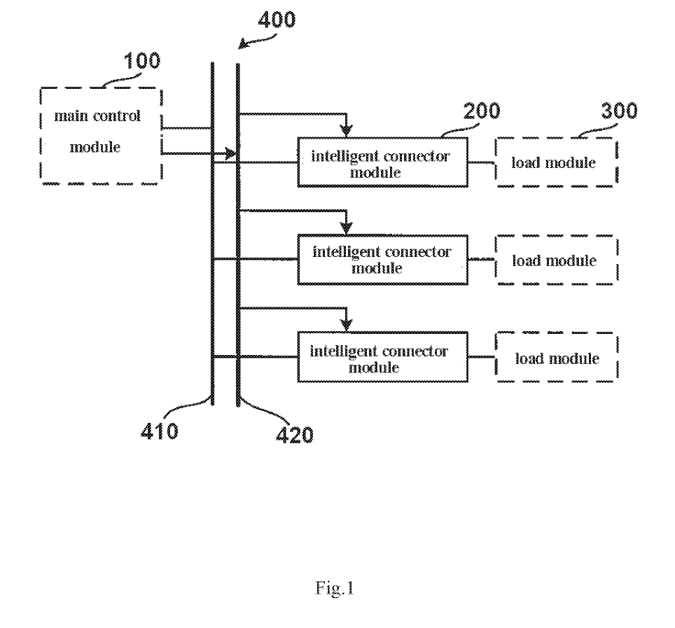

A bus control system of electrical equipment according to an embodiment is shown in FIG. 1. The bus control system comprises a single main control module 100, a plurality of intelligent connector modules 200, a plurality of load modules 300, and a bus 400. The single main control module 100 is coupled to the bus 400, and the plurality of load modules 300 are coupled to the bus 400 in parallel each through one of the plurality of intelligent connector modules 200.

The main control module 100, shown in FIG. 1, performs main control logic operation for the electrical equipment and transmits a control command to each intelligent connector module 200 through the bus 400. The main control module 100 receives information fed back from each intelligent connector module 200 through the bus 400. The plurality of intelligent connector modules 200 receive the control commands sent from the main control module 100 through the bus 400 and control the respective load modules 300 based on the received control commands.

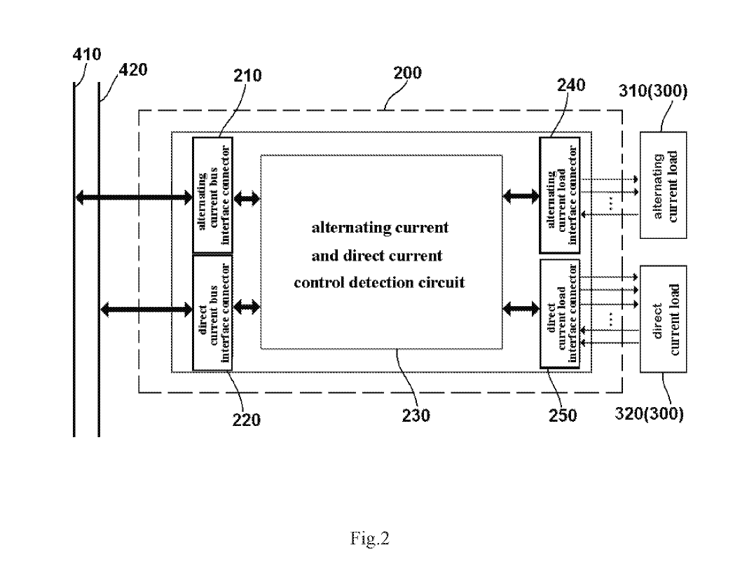

The intelligent connector module 200 is shown in FIGS. 1 and 2. The intelligent connector module 200 includes a plurality of bus interface connectors 210, 220, a plurality of load interface connectors 240, 250, and a control detection circuit 230. The bus interface connectors 210, 220 of the intelligent connector module 200 are adapted to be coupled to the bus 400 and the load interface connectors 240, 250 of the intelligent connector module 200 are adapted to be coupled to the load modules 300. The control detection circuit 230 of the intelligent connector module 200 is coupled between the bus interface connectors 210, 220 and the load interface connectors 240, 250.

The bus 400, as shown in FIGS. 1 and 2, includes an alternating current bus 410 and a direct current bus 420. Correspondingly, the bus interface connectors 210, 220 comprise an alternating current bus interface connector 210 coupled to the alternating current bus 410 and a direct current bus interface connector 220 coupled to the direct current bus 420.

The load modules 300, as shown in FIG. 2, each include an alternating current load 310 and a direct current load 320. Correspondingly, the load interface connectors 240, 250 comprise an alternating current load interface connector 240 coupled to the alternating current load 310, and a direct current load interface connector 250 coupled to the direct current load 320.

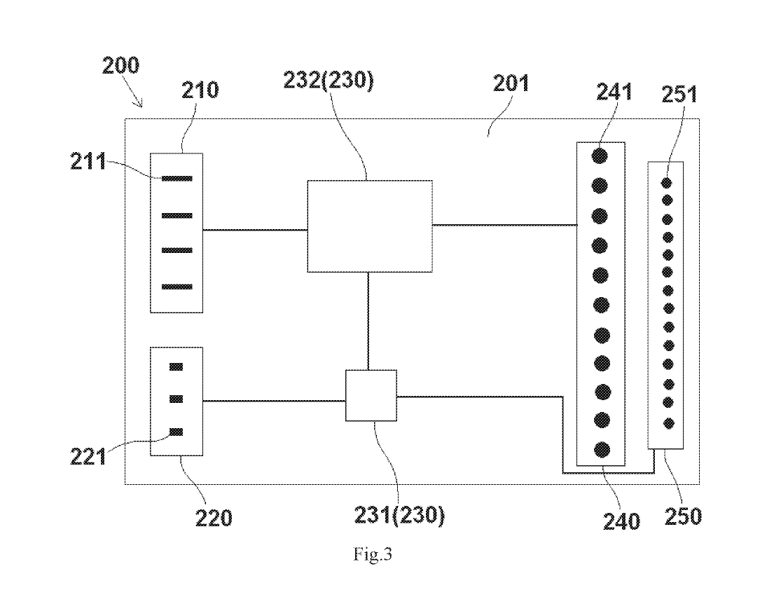

The intelligent connector module 200 is shown in a schematic, block diagram view in FIG. 2 and in a structural plan view in FIG. 3. As shown in FIG. 3, the intelligent connector module 200 is an integrated circuit board product having a printed circuit board 201. The bus interface connectors 210, 220, load interface connectors 240, 250, and the control detection circuit 230 are all integrated on the printed circuit board 201.

The control detection circuit 230, as shown in FIG. 3, includes a signal processing unit 231 and a switch control unit 232. The signal processing unit 231 is coupled between the direct current bus interface connector 220 and the direct current load interface connector 250 and is further coupled to the switch control unit 232. The switch control unit 232 is coupled between the alternating current bus interface connector 210 and the alternating current load interface connector 240. The switch control unit 232 is adapted to control a power supply fed to the alternating current load 310 based on a switch control signal from the signal processing unit 231. In an embodiment, the switch control unit 232 includes a relay.

The alternating current bus interface connector 210, the direct current bus interface connector 220, the signal processing unit 231, the switch control unit 232, the alternating current load interface connector 240 and the direct current load interface connector 250 are all integrated on the printed circuit board 201. As shown in FIG. 3, the alternating current bus interface connector 210 and the direct current bus interface connector 220 are disposed at a first end of the printed circuit board 201 and the alternating current load interface connector 240 and the direct current load interface connector 250 are disposed at a second end of the printed circuit board 201 opposite the first end. The signal processing unit 231 and the switch control unit 232 are disposed between the first end and the second end of the printed circuit board 201.

In the embodiment shown in FIG. 3, the alternating current bus interface connector 210 has four pins 211, which are a primary live wire input pin, an interlocking live wire output/input pin, a secondary live wire output/input pin, and a primary neutral line input pin, respectively. The direct current bus interface connector 220 has three pins 221, which are a half-duplex communication pin, a direct current supply pin, and a direct current ground pin, respectively.

The alternating current load interface connector 240, as shown in FIG. 3, has a plurality of pins 241 adapted to be connected to one or more alternating current loads 310. The plurality of pins 241 of the alternating current load interface connector 240 are adapted to be connected to a plurality of different alternating current loads 310. In different actual applications, the alternating current load interface connector 240 is connected to different alternating current loads 310, thereby improving the flexibility of the intelligent connector module 200. In the embodiment shown in FIG. 3, the alternating current load interface connector 240 has at least eleven pins 241. In other embodiments, the alternating current load interface connector 240 may comprise two to ten pins 241.

The direct current load interface connector 250, as shown in FIG. 3, has a plurality of pins 251 adapted to be connected to one or more direct current loads 320. The plurality of pins 251 of the direct current load interface connector 250 are adapted to be connected to a plurality of different direct current loads 320. In different actual applications, the direct current load interface connector 250 is connected to different direct current loads 320, thereby improving the flexibility of the intelligent connector module 200. In the embodiment shown in FIG. 3, the direct current load interface connector 250 has at least fourteen pins 251. In other embodiments, the direct current load interface connector 250 may comprise two to thirteen pins 251.

In other embodiments, each pin 241, 251 of the alternating current load interface connector 240 and the direct current load interface connector 250 may be varied as necessary, and thus the alternating current load interface connector 240 and the direct current load interface connector 250 may be flexibly arranged as necessary in the intelligent connector module 200.

The intelligent connector modules 200 are connected with each other through the bus 400. Each load module 300, such as a sensor, is connected to a nearby intelligent connector module 200 based on its installation position. Each intelligent connector module 200 controls an on or off state of each load module 300 according to the control command of the main control module 100 and feeds back the state value of the load module 300, such as a sensor state value, to the main control module 100. In an embodiment, the multifunctional direct current load interface connector 250 is flexibly arranged to be a digital I/O interface and an analog input interface so as to be connected to loads 320 having different functions, such as a valve, a fan, a heater, a sensor, or the like.

The intelligent connector modules 200 are adapted to couple the load modules 300 having different functions to the bus 400, providing a universality of application for the bus control system. Further, if there is a failure in a certain intelligent connector module 200, only this failed intelligent connector module 200, rather than the main control module 100 and other intelligent connector modules 200, must be replaced, decreasing repair difficulties and costs of the bus control system.

What is claimed is:

1. An intelligent connector module coupled to a bus and a load module of electrical equipment, the intelligent connector module comprising:
a circuit board;
a bus interface connector mounted on the circuit board and coupled to the bus;
a load interface connector mounted on the circuit board and coupled to the load module; and
a control detection circuit mounted on the circuit board and coupled between the bus interface connector and the load interface connector.

2. The intelligent connector module of claim 1, wherein the bus includes an alternating current bus and a direct current bus, and the bus interface connector includes an alternating current bus interface connector coupled to the alternating current bus and a direct current bus interface connector coupled to the direct current bus.

3. The intelligent connector module of claim 2, wherein the load module includes an alternating current load and a direct current load, and the load interface connector includes an alternating current load interface connector coupled to the alternating current load and a direct current load interface connector coupled to the direct current load.

4. The intelligent connector module of claim 3, wherein the control detection circuit includes a signal processing unit and a switch control unit.

5. The intelligent connector module of claim 4, wherein the signal processing unit is coupled between the direct current bus interface connector and the direct current load interface connector and is further coupled to the switch control unit.

6. The intelligent connector module of claim 5, wherein the switch control unit is coupled between the alternating current bus interface connector and the alternating current load interface connector and is adapted to control a power supply fed to the alternating current load based on a switch control signal from the signal processing unit.

7. The intelligent connector module of claim 6, wherein the switch control unit includes a relay.

8. The intelligent connector module of claim 6, wherein the circuit board is a printed circuit board and the alternating current bus interface connector, the direct current bus interface connector, the signal processing unit, the switch control unit, the alternating current load interface connector, and the direct current load interface connector are all integrated on the printed circuit board.

9. The intelligent connector module of claim 8, wherein the alternating current bus interface connector and the direct current bus interface connector are disposed at a first end of the printed circuit board.

10. The intelligent connector module of claim 9, wherein the alternating current load interface connector and the direct current load interface connector are disposed at a second end of the printed circuit board opposite the first end.

11. The intelligent connector module of claim 10, wherein the signal processing unit and the switch control unit are disposed between the first end and the second end of the printed circuit board.

12. The intelligent connector module of claim 8, wherein the alternating current bus interface connector has four pins which are a primary live wire input pin, an interlocking live wire output/input pin, a secondary live wire output/input pin, and a primary neutral line input pin.

13. The intelligent connector module of claim 8, wherein the direct current bus interface connector has three pins which are a half-duplex communication pin, a direct current supply pin, and a direct current ground pin.

14. The intelligent connector module of claim 8, wherein the alternating current load interface connector includes a plurality of pins connected to at least one alternating current load.

15. The intelligent connector module of claim 14, wherein the plurality of pins of the alternating current load interface connector are connected to a plurality of different alternating current loads.

16. The intelligent connector module of claim 15, wherein the alternating current load interface connector includes at least eleven pins.

17. The intelligent connector module of claim 8, wherein the direct current load interface connector includes a plurality of pins connected to at least one direct current load.

18. The intelligent connector module of claim 17, wherein the plurality of pins of the direct current load interface connector are connected to a plurality of different direct current loads.

19. The intelligent connector module of claim 18, wherein the direct current load interface connector includes at least fourteen pins.

20. A bus control system, comprising:
a bus;
a single main control module coupled to the bus;
a plurality of load modules; and
a plurality of intelligent connector modules each including a circuit board, a bus interface connector mounted on the circuit board and coupled to the bus, a load interface connector mounted on the circuit board and coupled to one of the load modules, and a control detection circuit mounted on the circuit board and coupled between the bus interface connector and the load interface connector, the plurality of load modules are coupled to the bus in parallel through the plurality of intelligent connector modules.
